(19) United States
(12) Patent Application Publication
(10) Pub. No.: US 2025/0180371 A1
(43) Pub. Date: Jun. 5, 2025

(54) INFORMATION PROCESSING DEVICE, INFORMATION PROCESSING METHOD, AND INFORMATION PROCESSING PROGRAM

(71) Applicant: Sony Group Corporation, Tokyo (JP)

(72) Inventor: Noriaki MACHINAKA, Tokyo (JP)

(73) Assignee: Sony Group Corporation, Tokyo (JP)

(21) Appl. No.: 18/844,069

(22) PCT Filed: Feb. 21, 2023
(86) PCT No.: PCT/JP2023/006134

§ 371 Date: Sep. 5, 2024

(30) Foreign Application Priority Data
Mar. 16, 2022 (JP) 2022-041589

(51) Int. Cl. G01C 21/00

(52) U.S. Cl. CPC G01C 21/3837; G01C 21/3807; G01C 21/3848; G01C 21/3856

(57) ABSTRACT

Provided is an information processing device, an information processing method, and an information processing program capable of improving mobility of an autonomous mobile body at a low cost. An information processing device according to an embodiment includes: a map creation unit that creates a map on the basis of obstacle position information indicating a position of an obstacle site that obstructs travel by a mobile device, and angle information indicating an angle at each travel position at which the mobile device travels of the mobile device.

### FIELD

The present disclosure relates to an information processing device, an information processing method, and an information processing program.

### BACKGROUND

An autonomous mobile body that autonomously travels using self position estimation by map matching is known. In the autonomous mobile body, autonomous travel is implemented by estimating a self position with reference to a map on the basis of an environment detected using a sensor, and controlling a travel speed, a travel direction and the like according to the estimated self position. As a sensor used for such autonomous mobile body, two dimensions-laser imaging detection and ranging (2D-LiDAR) that acquires an environment as two-dimensional information is generally used. Patent Literature 1 discloses a technology of estimating a position of a mobile device on the basis of a ranging result.

### CITATION LIST

### Patent Literature

Patent Literature 1: JP 2009-294104 A

### SUMMARY

### Technical Problem

In conventional self position estimation by map matching using the 2D-LiDAR, in many cases, it is assumed that a cart-type autonomous mobile body a posture of which does not change travels on a horizontal surface. In such a system, there is a case where a slope is determined as an obstacle site and travel is hindered. There also is a case where appearance of surroundings changes due to a change in posture of a self device, and erroneous determination occurs in map matching.

In contrast, it is also conceivable to mount a sensor capable of acquiring three-dimensional information such as three dimensions (3D)-LiDAR or a depth camera on the autonomous mobile body and recognize the environment as three-dimensional information. However, the 3D-LiDAR had a problem that this has many restrictions on an attaching position and a cost thereof increases. The depth camera has a problem that a measurable distance is relatively short, and is easily affected by a change in environment such as brightness.

An object of the present disclosure is to provide an information processing device, an information processing method, and an information processing program capable of improving mobility of an autonomous mobile body at a low cost.

### Solution to Problem

For solving the problem described above, an information processing device according to one aspect of the present disclosure has a map creation unit that creates a map on the basis of obstacle position information indicating a position of an obstacle site that obstructs travel by a mobile device, and angle information indicating an angle at each travel position at which the mobile device travels of the mobile device.

### BRIEF DESCRIPTION OF DRAWINGS

FIG. 1 is a schematic diagram illustrating an example of a map according to an existing technology.

FIG. 2 is a schematic diagram for describing a first example in a case where a surrounding environment is recognized using a 2D-LiDAR according to the existing technology.

FIG. 3 is a schematic diagram for describing a second example in a case where the surrounding environment is recognized using the 2D-LiDAR according to the existing technology.

FIG. 4 is a block diagram illustrating a configuration of an example of a mobile device as an autonomous mobile body applicable to each embodiment.

FIG. 5 is a block diagram illustrating a configuration of an example of an information processing device applicable to each embodiment.

FIG. 6 is a functional block diagram of an example for describing a function of the information processing device according to each embodiment.

FIG. 7A is a functional block diagram of an example for describing functions used at the time of map creation in the information processing device.

FIG. 7B is a functional block diagram of an example for describing functions used at the time of travel of the mobile device in the information processing device.

FIG. 8 is a flowchart of an example illustrating map creation processing applicable to each embodiment.

FIG. 9 is a schematic diagram illustrating an example of a map with angle information created in a first embodiment.

FIG. 10 is a schematic diagram illustrating an example of a data structure of the map with angle information according to the first embodiment.

FIG. 11 is a schematic diagram illustrating a specific example of the map with angle information according to the first embodiment.

FIG. 12 is a schematic diagram illustrating a specific example of the map with angle information according to the first embodiment.

FIG. 13 is a schematic diagram for describing a method of acquiring normal information applicable to a second embodiment.

FIG. 14 is a schematic diagram illustrating an example of a map with an angle by a normal vector according to the second embodiment.

FIG. 15 is a schematic diagram illustrating an example of a data structure of the map with angle information according to the second embodiment.

FIG. 16 is a schematic diagram illustrating an example of a data structure of a map with angle information according to a third embodiment.

FIG. 17 is a schematic diagram illustrating an example of a map with angle information created by a method according to a fourth embodiment.

### DESCRIPTION OF EMBODIMENTS

Hereinafter, embodiments of the present disclosure are described in detail with reference to the drawings. Note that, in the following embodiments, the same parts are denoted by the same reference signs, and redundant description is omitted.

Hereinafter, embodiments of the present disclosure will be described in the following order.
1. Regarding Existing Technology
2. Overview of Embodiments
   2-1. Configuration Applicable to Each Embodiment
   2-2. Map Creation Processing Applicable to Each
Embodiment
3. First Embodiment
4. Second Embodiment
5. Third Embodiment
6. Fourth Embodiment

### 1. Regarding Existing Technology

Before describing each embodiment of the present disclosure, an existing technology will be described for the purpose of understanding.

Regarding an operation of a mobile device (hereinafter, autonomous mobile body) that autonomously travels, a technology of controlling travel of the autonomous mobile body by using an obstacle site map in which an obstacle site that obstructs the travel of the autonomous mobile body is described created in advance is conventionally known.

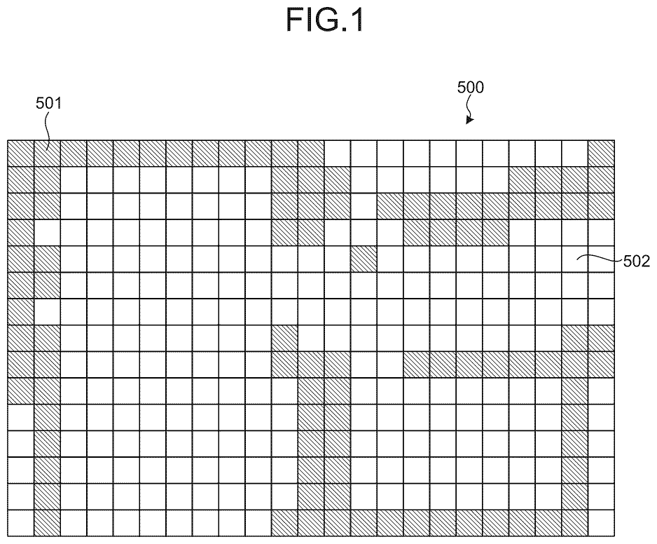

FIG. 1 is a schematic diagram illustrating an

example of the obstacle site map according to the existing technology. In an obstacle site map 500 illustrated in FIG. 1, an obstacle site 501 (hatched) is designated in units of regions divided by grids. For example, in a case where an existence probability of the obstacle site that obstructs the travel of the autonomous mobile body is a predetermined value or larger, a value indicating the probability is described in each obstacle site 501. In FIG. 1, a non-hatched region 502 indicates a site where the existence probability of the obstacle site is smaller than a predetermined value.

In a cart-type autonomous mobile body, as a sensor for performing self position estimation, two dimensions-laser imaging detection and ranging (2D-LiDAR) is generally used. For example, the 2D-LiDAR emits laser light in a direction parallel to a travel surface on which the autonomous mobile body travels to scan a predetermined angular range, performs ranging on the basis of reflected light thereof, and calculates two-dimensional coordinates of each point at which the reflected light is acquired. On the basis of the calculated coordinates, the autonomous mobile body performs map matching with an obstacle site map prepared in advance, and estimates a self position.

In the conventional self position estimation by the map matching using the 2D-LiDAR, in many cases, it has been assumed that a cart a posture (inclination and the like) of which does not change travels on a horizontal surface. In such a system, there has been a case where a slope is determined as the obstacle site and the travel is disabled. There also has been a case where appearance of surroundings changes due to a change in posture of the self device, and the map matching goes wrong.

Note that, it is assumed that the horizontal surface is a surface orthogonal to a direction of gravity.

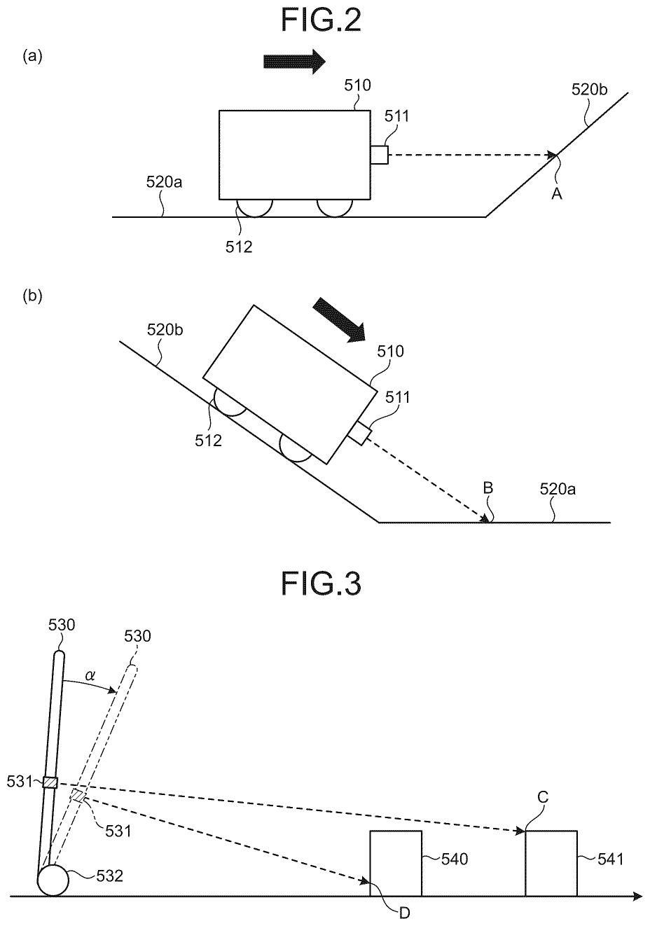

FIG. 2 is a schematic diagram for describing a first example in a case where a surrounding environment is recognized using the 2D-LiDAR according to the existing technology. In sections (a) and (b) of FIG. 2, a cart-type autonomous mobile body 510 travels on the travel surface by a wheel 512 driven by a motor. A ranging device 511, which is the 2D-LiDAR, is attached to the autonomous mobile body 510 at a predetermined position (predetermined height) on a front surface (surface in a travel direction).

Section (a) of FIG. 2 illustrates an example in which the autonomous mobile body 510 travels on a horizontal surface 520a in a direction indicated by a white arrow in the drawing, and there is an ascending slope 520b at a travel destination. In a case of this example, a position A corresponding to an attached height of the ranging device 511 is detected on the slope 520b by the ranging device 511. In this case, even when an angle formed by the slope 520b and the horizontal surface 520a is an angle at which the autonomous mobile body 510 can climb, the slope 520b might be recognized as the obstacle site to the travel of the autonomous mobile body 510, and the travel of the autonomous mobile body 510 might be disabled.

Section (b) of FIG. 2 illustrates an example in which the autonomous mobile body 510 travels on the slope 520b in a direction indicated by a white arrow (descends the slope 520b) to travel toward the horizontal surface 520a. In a case of this example, a position B corresponding to the attached height of the ranging device 511 with respect to the slope 520b is detected on the horizontal surface 520a by the ranging device 511. In this case, even when an angle formed by the slope 520b and the horizontal surface 520a is an angle at which the autonomous mobile body 510 can travel, the horizontal surface 520a might be recognized as an obstacle site to the travel of the autonomous mobile body 510, and the travel of the autonomous mobile body 510 might be disabled.

FIG. 3 is a schematic diagram for describing a second example in a case where the surrounding environment is recognized using the 2D-LiDAR according to the existing technology. In FIG. 3, an inverted pendulum type autonomous mobile body 530 travels on the travel surface by a wheel 532 driven by a motor, and an angle of the autonomous mobile body 530 is variable about the wheel 532. A ranging device 531, which is the 2D-LiDAR, is attached to the autonomous mobile body 530 at a predetermined position (predetermined height) on a front surface (surface in a travel direction).

In a case of the example of FIG. 3, in a case where the autonomous mobile body 530 is in a posture indicated by a solid line in the drawing, by the ranging device 531, a position C on an upper end on a front side as seen from the autonomous mobile body 530 of an object 541 is detected, and an object 540 located on a front side with respect to the object 541 is not detected. On the other hand, in the example of FIG. 3, in a case where the autonomous mobile body 530 takes a forward tilting posture in the travel direction by an angle α with respect to the posture indicated by the solid line as indicated by a dotted line in the drawing, a position D of the object 540 is detected, and the object 541 is not detected. In this manner, the appearance of the surroundings might change according to the posture of the autonomous mobile body 530. In this example, in a case where the autonomous mobile body 530 takes the posture indicated by the solid line, the object 540 cannot be recognized, so that when this travels in a direction of the object 540, this collides with the object 540.

In contrast, it is also conceivable to mount a sensor capable of acquiring three-dimensional information such as three dimensions (3D)-LiDAR or a depth camera on the autonomous mobile body and recognize the environment as three-dimensional information. However, the 3D-LiDAR has many restrictions on an attaching position and a cost thereof increases. The depth camera has a relatively short measurable distance, and is easily affected by a change in environment such as brightness.

### 2. Overview of Embodiments

Next, an overview of the embodiments according to the present disclosure will be described.

In each embodiment according to the present disclosure, the obstacle site map is provided with angle information indicating an angle at each position together with the existence probability of the obstacle site. The angle information may be, for example, a normal vector of the travel surface. Alternatively, the angle information may be information indicating the posture of the autonomous mobile body.

In this manner, in each embodiment according to the present disclosure, the obstacle site map is provided with the angle information at each position. As a result, by applying the present disclosure, it is possible to facilitate travel control in an environment including a slope or travel control regarding a change in posture of the autonomous mobile body itself by the autonomous mobile body using only the 2D-LiDAR as the sensor for detecting the environment, and to improve mobility of the autonomous mobile body at a low cost.

### 2-1. Configuration Applicable to Each Embodiment

A configuration applicable to each embodiment of the present disclosure will be described.

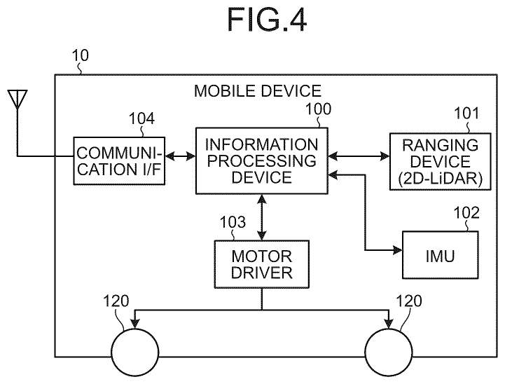

FIG. 4 is a block diagram illustrating a configuration of an example of the mobile device as the autonomous mobile body applicable to each embodiment. Hereinafter, in a case where it is not particular described, it is described assuming that the mobile device is a cart-type mobile device.

In FIG. 4, a mobile device 10 applicable to each embodiment includes an information processing device 100, a ranging device 101, an inertial measurement unit (IMU) 102, a motor driver 103, and a communication interface (I/F) 104.

The information processing device 100 has a configuration as a general computer, for example, and includes a central processing unit (CPU), a read only memory (ROM), a random access memory (RAM), a storage device, an input device, a display, and various I/Fs.

The ranging device 101 is a device that performs ranging in a two-dimensional planar shape. Hereinafter, the 2D-LiDAR is applied as the ranging device 101. The ranging device 101 is attached at a predetermined height of the mobile device 10, emits laser light in a direction parallel to a travel surface on which the mobile device 10 travels to scan a predetermined angular range, performs ranging on the basis of reflected light thereof, and calculates two-dimensional coordinates at each point at which the reflected light is acquired. The ranging device 101 outputs a point group (2D point group) of points each having two-dimensional coordinates as a ranging result.

The IMU 102 detects angles or angular velocities of three axes related to motion, and acceleration. For example, the IMU 102 includes a three-axis gyroscope and a three-direction accelerometer, and outputs three-dimensional angular velocity and acceleration. On the basis of the output of the IMU 102, posture information indicating the posture of the mobile device 10 can be acquired. The posture information includes, for example, angle information of each of xyz components in a case where a direction of gravity is a z-axis, and rotation information by roll, pitch, and yaw.

The motor driver 103 operates a motor (not illustrated) for driving a travel unit 120 for causing the mobile device 10 to travel according to a control signal output from the information processing device 100. The communication I/F 104 communicates with an external device using, for example, wireless communication. There is no limitation, and the communication I/F 104 may communicate with the external device by using wired communication. For example, by communicating with an external controller via the communication I/F 104, the travel of the mobile device 10 can be controlled from the controller.

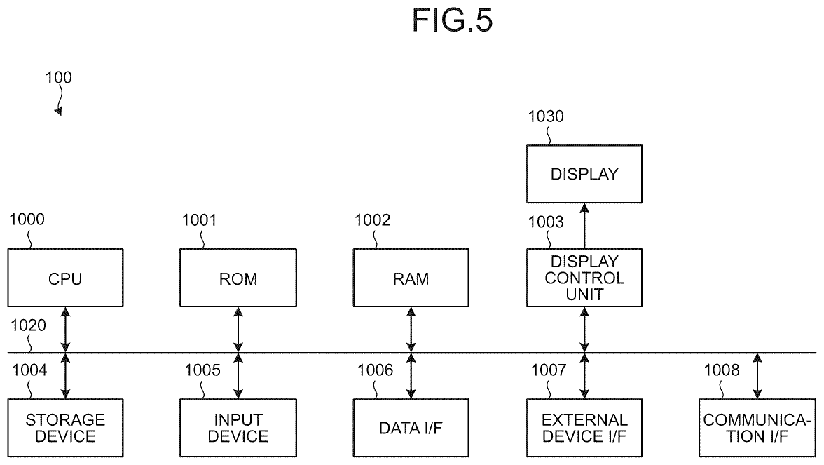

FIG. 5 is a block diagram illustrating a configuration of an example of the information processing device 100 applicable to each embodiment. In FIG. 5, the information processing device 100 includes a CPU 1000, a ROM 1001, a RAM 1002, a display control unit 1003, a storage device 1004, an input device 1005, a data I/F 1006, an external device I/F 1007, and a communication I/F 1008 connected to one another so as to be able to communicate via a bus 1020.

The storage device 1004 is a nonvolatile storage medium such as a hard disk drive or a flash memory. The CPU 1000 controls an entire operation of the information processing device 100 by using the RAM 1002 as a work memory according to a program stored in the ROM 1001 or the storage device 1004.

The display control unit 1003 converts a display control signal generated by the CPU 1000 into a display signal in a format displayable by a display 1030, and outputs the same to the display 1030. The input device 1005 receives an input by a user operation, and a keyboard, a pointing device, a touch panel and the like can be applied thereto.

The data I/F 1006 is an interface for transmitting and receiving data to and from an external device. The external device I/F 1007 outputs a control signal to the external device, and receives information (status information and the like) transmitted from the external device. For example, the information processing device 100 is connected to the motor driver 103 via the external device I/F 1007, and transmits the control signal to the motor driver 103. The communication I/F 1008 performs communication via an external communication network by, for example, wireless communication.

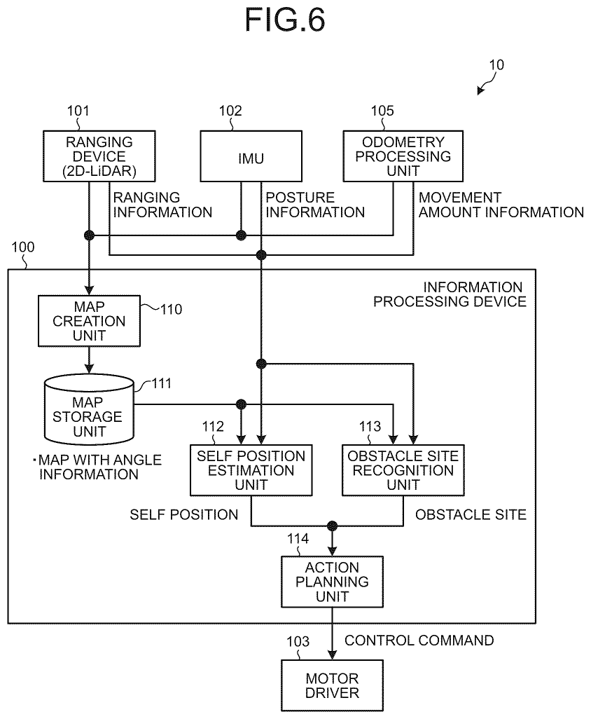

FIG. 6 is a functional block diagram of an example for describing a function of the information processing device 100 according to each embodiment.

In FIG. 6, the information processing device 100 includes a map creation unit 110, a map storage unit 111, a self position estimation unit 112, an obstacle site recognition unit 113, and an action planning unit 114.

Among them, the map storage unit 111 is, for example, a predetermined storage area in the storage device 1004. The map creation unit 110, the self position estimation unit 112, the obstacle site recognition unit 113, and the action planning unit 114 are configured by, for example, an operation of an information processing program according to the embodiment on the CPU 1000. There is no limitation, and some or all of the map creation unit 110, the self position estimation unit 112, the obstacle site recognition unit 113, and the action planning unit 114 may be configured by hardware circuits that operate in cooperation with each other.

The map creation unit 110 receives an input of ranging information (2D point group) output from the ranging device 101, the posture information indicating the posture of the mobile device 10 output from the IMU 102, and movement amount information indicating a movement amount of the mobile device 10 output from an odometry processing unit 105.

Note that, the odometry processing unit 105 obtains a moving direction, a moving distance and the like of the mobile device 10 using, for example, an acceleration sensor and the like, and acquires the movement amount information. As an example, the odometry processing unit 105 can estimate a current position of the mobile device 10 by integrating a rotation angle of an axle in the travel unit 120, for example. The odometry processing unit 105 can obtain the moving distance by accumulating the estimated current position in time series.

The map creation unit 110 creates a map with angle information including angle information at each position on the basis of the 2D point group and the posture information. The map creation unit 110 stores the created obstacle site map and map with angle information in the map storage unit 111.

That is, the map creation unit 110 serves as a map creation unit that creates a map on the basis of obstacle position information indicating a position of the obstacle site that obstructs the travel by the mobile device and angle information indicating an angle of the mobile device at each travel position at which the mobile device travels.

The self position estimation unit 112 estimates the self position of the mobile device 10 on the basis of the ranging information, posture information, and movement amount information, and the map with angle information stored in the map storage unit 111. The obstacle site recognition unit 113 recognizes the obstacle site that might be an obstacle for the travel of the mobile device 10 on the basis of the ranging information, posture information, and movement amount information, and the map with angle information stored in the map storage unit 111.

The action planning unit 114 creates a travel plan of the mobile device 10 on the basis of a self position estimated by the self position estimation unit 112 and the obstacle site recognized by the obstacle site recognition unit 113. For example, in a case where the self position moves toward the obstacle site, the action planning unit 114 creates the travel plan so as to travel to avoid the obstacle site. The action planning unit 114 generates a control command for controlling drive of the motor driver 103 on the basis of the created travel plan.

Note that, in the above description, for example, as illustrated in FIG. 4, the information processing device 100 is illustrated to be built in the mobile device 10, but this is not limited to this example. For example, some of functions of the information processing device 100 may be configured outside the mobile device 10. For example, among the functions of the information processing device 100, the map creation unit 110 can be configured outside the mobile device 10. On the other hand, among the functions of the information processing device 100, the functions other than the map creation unit 110, that is, the self position estimation unit 112, the obstacle site recognition unit 113, the action planning unit 114, and the map storage unit 111 are preferably built in the mobile device 10.

The information processing device 100 illustrated in FIG. 6 uses different functions at the time of map creation by the map creation unit 110 and the time of travel of the mobile device 10 based on the action plan created by the action planning unit 114.

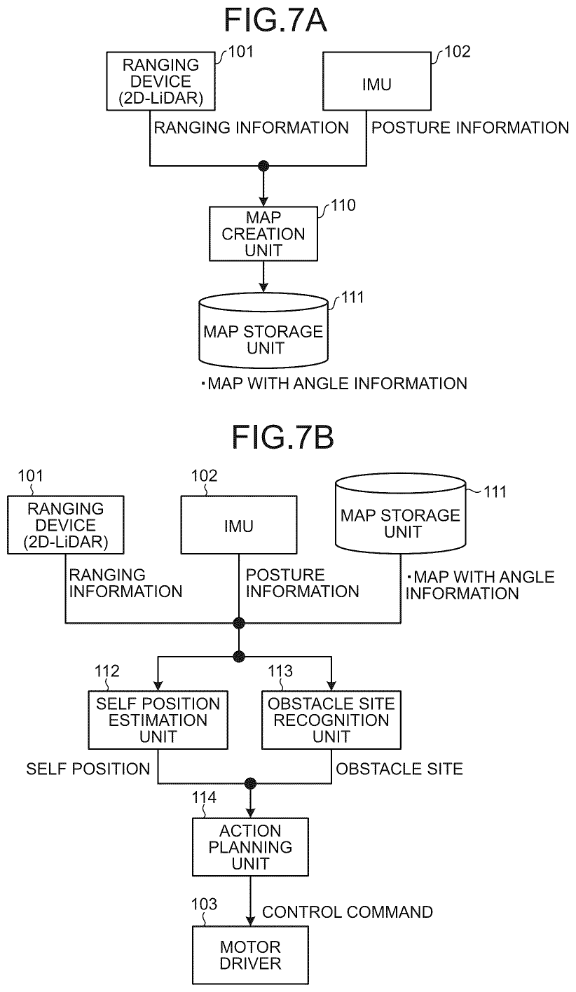

FIG. 7A is a functional block diagram of an example for describing functions used at the time of map creation in the information processing device 100. As illustrated in FIG. 7A, at the time of map creation, only the map creation unit 110 is used among the functions illustrated in FIG. 6. At the time of map creation, the map creation unit 110 creates the map with angle information using the outputs of the ranging device 101 and the IMU 102.

FIG. 7B is a functional block diagram of an example for describing functions used at the time of travel of the mobile device 10 in the information processing device 100. As illustrated in FIG. 7B, when the mobile device 10 travels, the self position estimation unit 112, the obstacle site recognition unit 113, and the action planning unit 114 are used among the functions illustrated in FIG. 6. The self position estimation unit 112 and the obstacle site recognition unit 113 obtain the self position and the obstacle site, respectively, using the outputs of the ranging device 101 and the IMU 102 and the map with angle information stored in the map storage unit 111. Note that, the self position estimation unit 112 may estimate the self position by further using the movement amount information output from the odometry processing unit 105.

In the information processing device 100, the CPU 1000 configures the above-described map creation unit 110 in a main storage area in the RAM 1002, for example, as a module by execution of an information processing program for implementing the function according to the embodiment. Furthermore, the CPU 1000 may configure the above-described self position estimation unit 112, obstacle site recognition unit 113, and action planning unit 114 in the main storage area in the RAM 1002, for example, as modules by execution of the information processing program for implementing the function according to the embodiment.

The information processing program can be externally acquired via a network not illustrated by communication via the communication I/F 1008, for example, and can be installed on the information processing device 100. There is no limitation, and the information processing program may be provided by being stored in a detachable storage medium such as a compact disk (CD), a digital versatile disk (DVD), or a universal serial bus (USB) memory.

### 2-2. Map Creation Processing Applicable to Each Embodiment

Next, map creation processing applicable to each embodiment will be schematically described. Hereinafter, a case where the map creation unit 110 creates the map with angle information will be described.

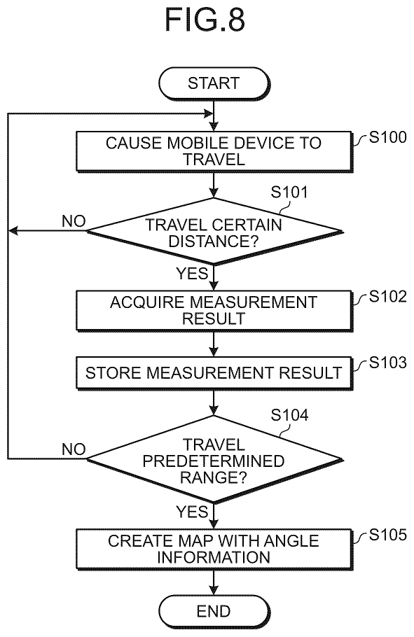

FIG. 8 is a flowchart of an example illustrating the map creation processing applicable to each embodiment. At step S100, the mobile device 10 is caused to travel. At step S100, for example, the mobile device 10 may be caused to travel in a direction indicated by an external controller. There is no limitation, and the mobile device 10 may be caused to travel in a random direction, for example, at step S100.

At next step S101, the information processing device 100 determines whether the mobile device 10 travels a certain distance. For example, on the assumption that the travel surface on which the mobile device 10 travels is a flat surface, the map creation unit 110 sets grids of a predetermined size with respect to the flat surface. At step S101, the information processing device 100 determines whether the mobile device 10 travels one block of the grids.

In a case where the information processing device 100 determines that the mobile device 10 does not travel a predetermined distance (step S101, “No”), this returns the processing to step S100. On the other hand, in a case where the information processing device 100 determines that the mobile device 10 travels the predetermined distance (step S101, “Yes”), this shifts the processing to step S102.

At step S102, the information processing device 100 acquires measurement results (ranging information and posture information) of measurement by the ranging device 101 and the IMU 102. At next step S103, the information processing device 100 stores the measurement results acquired at step S102. The information processing device 100 may store the acquired measurement results in the RAM 1002 or the storage device 1004.

At next step S104, the information processing device 100 determines whether the mobile device 10 travels a certain range. In a case where the information processing device 100 determines that the mobile device 10 does not travel the predetermined range (step S104, “No”), this returns the processing to step S100. On the other hand, in a case where the information processing device 100 determines that the mobile device 10 travels the predetermined range at step S104 (step S104, “Yes”), this shifts the processing to step S105.

At step S105, the information processing device 100 creates the map with angle information by using each measurement result stored at step S103.

### 3. First Embodiment

Next, a first embodiment of the present disclosure will be described. The first embodiment is an example of creating a map having posture information indicating a posture at that time as a channel when creating a map according to grids. That is, in the first embodiment, a map with angle information having the posture information as angle information for each grid is created.

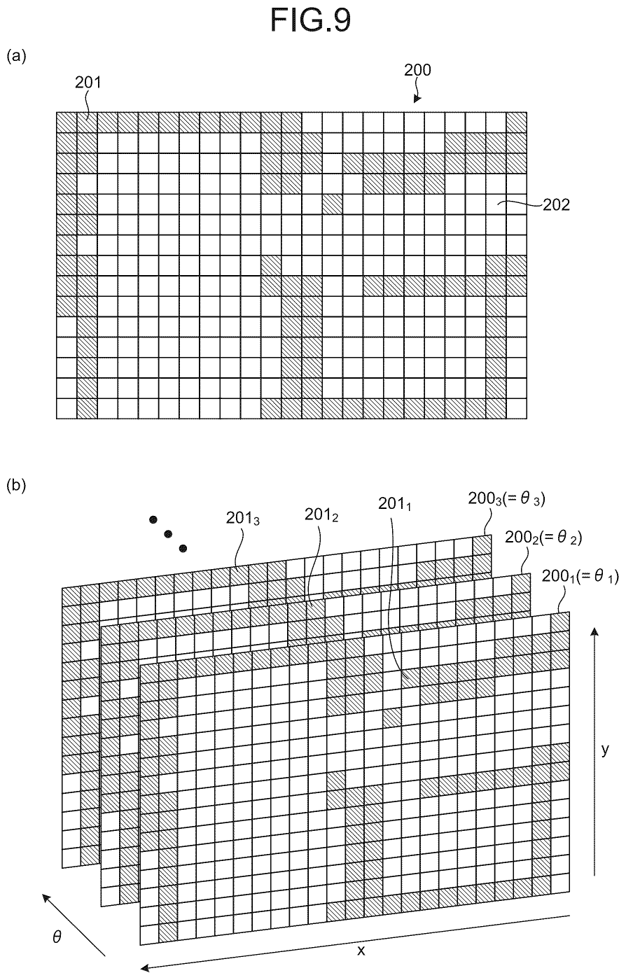

FIG. 9 is a schematic diagram illustrating an example of the map with angle information created in the first embodiment. Section (a) of FIG. 9 illustrates an example of a map with angle information 200 in a certain posture (angle). In the map with angle information 200 illustrated in section (a), similarly to the obstacle site map 500 according to the existing technology described with reference to FIG. 1, an obstacle site 201 (hatched) is designated in units of regions divided by grids. The obstacle site 201 is a site where an existence probability of the obstacle site is a predetermined value or larger in a case where the angle indicated by the posture information of the mobile device 10 is the angle designated in the map with angle information 200. On the other hand, in FIG. 9, for example, a site where the existence probability of the obstacle site is smaller than a predetermined value at the angle is indicated as a non-hatched region 202.

In the first embodiment, as illustrated in section (b) of FIG. 9, maps with angle information 200₁, 200₂, 200₃, . . . are created for each angle θ indicated by the posture information of the mobile device 10. In section (b), the map with angle information 200₁ is a map in a case where the posture information of the mobile device 10 is an angle θ₁, and a position of the angle θ₁ is indicated as the obstacle site 201₁. The maps with angle information 200₂ and 200₃ are similarly maps in a case where the posture information of the mobile device 10 is angles θ₂ (>θ₁) and θ₃ (>θ₂), and the positions at the angles θ₂ and θ₃ indicate obstacle sites 201₂ and 201₃, respectively.

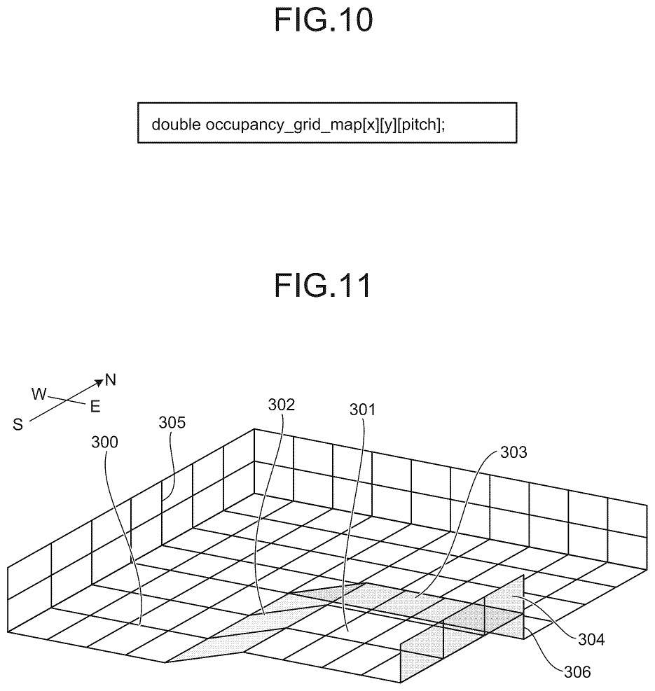

FIG. 10 is a schematic diagram illustrating an example of a data structure of the map with angle information 200 according to the first embodiment. In the map with angle information 200, a value of an existence probability of the obstacle site (double occupancy_grid_map) is described using coordinates (x, y) indicating a grid position where an existence possibility of the obstacle site is detected and an angle θ (pitch) at the position where the obstacle site is detected as parameters. For example, in a case where the existence probability of the obstacle site is a predetermined value or larger, the mobile device 10 may determine that the coordinates thereof are the obstacle site.

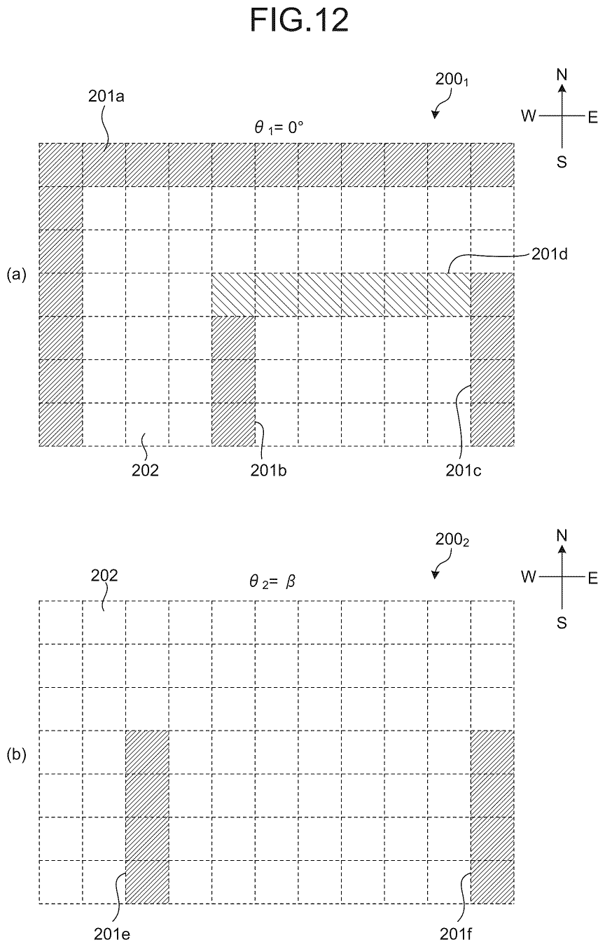

FIGS. 11 and 12 are schematic diagrams illustrating a specific example of the map with angle information 200 according to the first embodiment. FIG. 11 illustrates an example of an assumed travel environment as an overhead view. Note that, for the sake of description, it is assumed that north (N) is upper right in FIG. 11. It is assumed that a north (N) -south (S) axis corresponds to an x-axis, and a west (W) -east (E) axis corresponds to a y-axis.

In the example in FIG. 11, walls 305 perpendicular to a horizontal surface 300 exist at a west (W) end and a north (N) end of the horizontal surface 300. A horizontal platform 301 connected to the horizontal surface 300 from the west (W) by a slope 302 exists in a southeast (S-E) portion in the drawing. An east (E) end of the platform 301 is a wall 304 perpendicular to the platform 301, and a north end of the platform 301 is a perpendicular portion 306 perpendicular to the platform 301 and the horizontal surface 300. Note that, the slope 302 is inclined at an angle β with respect to the horizontal surface 300.

FIG. 12 schematically illustrates an example of the maps with angle information 200₁ and 200₂ created by the map creation unit 110 on the basis of the travel environment illustrated in FIG. 11 as a top view as compared with the overhead view of FIG. 11.

Section (a) of FIG. 12 illustrates an example of the map with angle information 200₁ in a case where the angle θ₁ indicated by the posture information=0°. For example, section (a) illustrates an example of a case where the mobile device 10 travels in a direction parallel to the horizontal surface 300.

In section (a) of FIG. 12, the position where the wall 305 is detected of FIG. 11 is indicated as an obstacle site 201a, and the position where the wall 304 is detected is indicated as an obstacle site 201c. The position where the slope 302 is detected is indicated as an obstacle site 201b. Furthermore, the position where the perpendicular portion 306 is detected is indicated as an obstacle site 201d.

Section (b) of FIG. 12 illustrates an example of the map with angle information 2002 in a case where the angle θ₂ indicated by the posture information=β. For example, section (b) illustrates an example of a case where the mobile device 10 travels on the slope 302.

In section (b) of FIG. 12, for example, in a case where the mobile device 10 goes down the slope 302 (travels to the west), a region of the horizontal surface 300 at the travel destination of the slope 302 is detected and is indicated as an obstacle site 201e. In an example of section (b), for example, in a case where the mobile device 10 climbs the slope 302 (travels to the east), the wall 304 at the travel destination of the slope 302 is detected and is indicated as an obstacle site 201f.

The map creation unit 110 stores the map with angle information 200₁ and 200₂ created in this manner in the map storage unit 111.

Processing when using these maps with angle information 200₁ and 200₂ will be schematically described. In the mobile device 10, the self position estimation unit 112 estimates the self position on the basis of, for example, the movement amount information, the ranging information, and the posture information acquired by the ranging device 101, the IMU 102, and the odometry processing unit 105, respectively. The self position estimation unit 112 passes information indicating the estimated self position to the action planning unit 114.

The obstacle site recognition unit 113 obtains the angle θ of the mobile device 10 with respect to, for example, the horizontal surface 300 on the basis of the posture information acquired by the IMU 102. The obstacle site recognition unit 113 acquires the map with angle information 200 corresponding to the obtained angle θ from each of the maps with angle information 2001 and 200₂ stored in the map storage unit 111. The obstacle site recognition unit 113 recognizes the obstacle site 201 on the basis of the acquired map with angle information 200, and passes information indicating the recognized obstacle site 201 to the action planning unit 114.

The action planning unit 114 creates the travel plan of the mobile device 10 on the basis of the information indicating the self position passed from the self position estimation unit 112, and the information indicating the obstacle site 201 passed from the obstacle site recognition unit 113. For example, in a case where the position of the mobile device 10 approaches the position indicated at the obstacle site 201 on the basis of these pieces of information, the action planning unit 114 creates a travel plan for indicating the travel avoiding the obstacle site 201, and passes a control command according to the created travel plan to the motor driver 103.

In this manner, in the first embodiment, by providing the angle information to the map based on two-dimensional information, it is possible to detect the slope 302 and the like without using a sensor capable of acquiring three-dimensional information, and create the travel plan based on a detection result. Therefore, by applying the first embodiment, the mobility of the autonomous mobile body can be improved at a low cost.

Note that, in the above description, a map corresponding to the posture of the mobile device 10 is selected from the plurality of maps with angle information 200₁, 200₂, . . . , but it is no limited to this example. For example, the information processing device 100 may integrate the maps with angle information 200 of a plurality of channels in such a manner that the position of the obstacle site 201 is made highly reliable information on the basis of the travel position of the mobile device 10 when the obstacle site 201 is detected in each map, and use the same as one map. As a method of integration processing in this case, known Bayesian updating may be used.

### 4. Second Embodiment

Next, a second embodiment of the present disclosure will be described. The second embodiment is an example of obtaining normal information for each grid when creating a map according to grids, and creating the map in which the normal information is added to information indicating a position of the grid for each grid. That is, in the second embodiment, a map with angle information having the normal information as angle information for each grid is created. It can also be said that this map with angle information is a normal information map having the normal information for each grid.

FIG. 13 is a schematic diagram for describing a method of acquiring the normal information applicable to the second embodiment. An angle (inclination) of a travel surface on which a mobile device 10 travels can be acquired on the basis of a speed vector by travel of the mobile device 10 or posture information indicating a posture of the mobile device 10. A map creation unit 110 obtains an angle with respect to a direction of gravity of the mobile device 10 on the basis of the posture information acquired from an IMU 102, for example. The map creation unit 110 acquires the obtained angle as the normal information at a current position of the mobile device 10 of the travel surface on which the mobile device 10 travels.

In an example of FIG. 13, a case is illustrated where the mobile device 10 travels on the travel surface in a direction indicated by an arrow in the drawing, goes down a slope 211 from a horizontal surface 210, and moves toward a horizontal surface 212. Note that, in FIG. 13, a right end of the horizontal surface 212 is a vertical wall 213.

In this case, it is assumed that the map creation unit 110 acquires the posture information from the IMU 102 at a position 401 of the slope 211, for example. The map creation unit 110 obtains an angle with respect to a direction of gravity of the mobile device 10 on the basis of the acquired posture information. On the basis of this angle, the map creation unit 110 can acquire a normal vector 400 as the normal information at the position 401.

Note that, the map creation unit 110 obtains the normal vector 400 as a vector with the center of a unit sphere of radius=1 as an origin, and acquires an x component and a y component at that time as numerical values. In FIG. 13, a direction 410 of the speed vector of the mobile device 10 on the slope 211 is parallel to a surface of the slope 211.

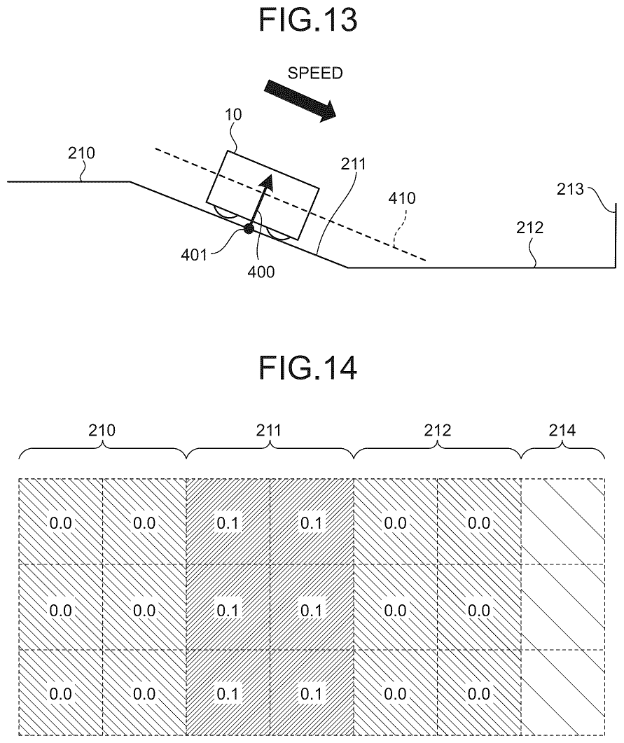

FIG. 14 is a schematic diagram illustrating an example of the map with angle information by the normal vector according to the second embodiment.

In FIG. 14, a map with angle information 250 includes a value of the normal vector for each grid. In this example, a value of the x component out of the x component and the y component of the normal vector is indicated for each grid. In the example in the drawing, it is illustrated that each grid on the horizontal surfaces 210 and 212 has a value=0.0, the x component is 0, and each grid is horizontal. On the other hand, it is illustrated that each grid on the slope 211 has a value=0.1, the x component is 0.1, and each grid has an inclination corresponding to x=0.1.

Note that, in FIG. 14, a region 214 indicates a region on a right side of the wall 213 in FIG. 13. Since the mobile device 10 cannot travel in this region 214, posture information and the like are not acquired.

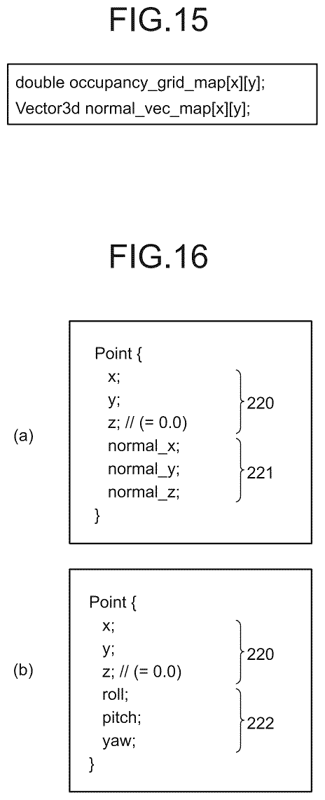

FIG. 15 is a schematic diagram illustrating an example of a data structure of the map with angle information 250 according to the second embodiment. The map with angle information 250 includes a value of an existence probability of an obstacle site (double occupancy_grid_map) described using coordinates (x, y) indicating a grid position where an existence possibility of the obstacle site is detected as a parameter and data (Vector3d normal_vec_map) indicating the normal vector described by using the coordinates (x, y) as a parameter. That is, the map with angle information 250 according to the second embodiment includes a map indicating the obstacle site for each grid and a map indicating the normal vector for each grid.

The map creation unit 110 stores the map with angle information 250 created in this manner in a map storage unit 111.

Processing when using the map with angle information 250 will be schematically described. In the mobile device 10, a self position estimation unit 112 estimates a self position on the basis of, for example, movement amount information, ranging information, and posture information acquired by a ranging device 101, the IMU 102, and an odometry processing unit 105, respectively.

The self position estimation unit 112 passes information indicating the estimated self position to an action planning unit 114.

An obstacle site recognition unit 113 recognizes the obstacle site with reference to the map with angle information 250 stored in the map storage unit 111. The obstacle site recognition unit 113 passes information indicating the recognized obstacle site to the action planning unit 114.

The action planning unit 114 refers to data indicating the normal vector of the map with angle information 250 stored in the map storage unit 111 on the basis of the information indicating the self position passed from the self position estimation unit 112, and obtains the normal vector at the current position. For example, the action planning unit 114 creates a travel plan of the mobile device 10 on the basis of the normal vector at the current position, and information indicating the obstacle site passed from the obstacle site recognition unit 113.

Position information indicating a position of the normal vector and position information indicating the obstacle site have coordinates of one-to-one correspondence. Therefore, for example, the action planning unit 114 can obtain the inclination at the current position of the mobile device 10 on the basis of the information indicating the estimated self position. The action planning unit 114 can calculate the obstacle site detected at the obtained inclination from the position information indicating the position of the normal vector and the position information indicating the obstacle site.

As a specific example, for example, in FIG. 13, for the mobile device 10 at the position 401 on the slope 211, a predetermined position on the horizontal surface 212 in a travel direction is seen as the obstacle site. On the other hand, for example, when referring to the data indicating the normal vector of the map with angle information 250, the obstacle site recognition unit 113 recognizes that the predetermined position on the horizontal surface 212 is a horizontal surface. On the basis of a distance to the obstacle site and the current inclination of the mobile device 10, the obstacle site recognition unit 113 can calculate that the predetermined position on the horizontal surface 212 is not the obstacle site but the surface on which this can travel. In this manner, the obstacle site recognition unit 113 can perform matching on the basis of the value of the existence probability of the obstacle site included in the map with angle information 250 and the normal vector, and extract the obstacle site that mighty actually obstruct the travel.

The action planning unit 114 can create the travel plan of the mobile device 10 according to the obstacle site detected in this manner.

For example, in a case where the position of the mobile device 10 approaches the position indicated at the obstacle site 201 on the basis of information indicating the obstacle site, or a case where the mobile device 10 approaches a position where it is difficult to climb on the basis of the normal vector, the action planning unit 114 may create the travel plan for indicating the travel avoiding the obstacle site 201. There is no limitation, and the action planning unit 114 may create, on the basis of the normal vector, the travel plan indicating the travel at a reduced travel speed in a case where the mobile device 10 approaches the slope 211.

The action planning unit 114 passes a control command according to the created travel plan to the motor driver 103.

In this manner, in the second embodiment, by providing the angle information to the map based on two-dimensional information, it is possible to detect the slope 211 and the like without using a sensor capable of acquiring three-dimensional information, and create the travel plan based on a detection result. Therefore, by applying the second embodiment, the mobility of the autonomous mobile body can be improved at a low cost.

Note that, it is not limited to the above example, and the information processing device 100 may integrate values of a plurality of normal vectors acquired by a plurality of times of measurement on the same travel surface to acquire a value in each grid. As a method of integration processing of the values of the normal vectors, known Bayesian updating may be used. The information processing device 100 may detect the obstacle site from a plurality of travel surfaces (for example, the horizontal surface 210, slope 211, and horizontal surface 212) and integrate pieces of information acquired from the plurality of travel surfaces so as to increase reliability of the detected obstacle site. Furthermore, the information processing device 100 may perform matching by extracting the obstacle site coinciding with the current posture of the mobile device 10 or the inclination of the travel surface on the basis of the normal vector.

### 5. Third Embodiment

Next, a third embodiment of the present disclosure will be described. The third embodiment is an example in which coordinate information and posture information are included in one data structure in a map with angle information.

FIG. 16 is a schematic diagram illustrating an example of the data structure of the map with angle information according to the third embodiment. In FIG. 16, section (a) illustrates an example of the data structure including obstacle site information 220 indicating a position of an obstacle site and self device position information 221 indicating a position of a mobile device 10 when the obstacle site information 220 is acquired in one data. More specifically, the obstacle site information 220 includes coordinates (x, y, z) detected as the obstacle site. Note that, a value of a coordinate z is fixed to 0. The self device position information 221 includes coordinates (normal_x, normal_y, normal_z) indicating a position of the mobile device 10.

There is no limitation, and the coordinates (normal_x, normal_y, normal_z) included in the self device position information 221 may be information (for example, a normal vector) indicating an inclination at a position indicated by the obstacle site information 220 in the same data.

Here, the mobile device 10 acquires a 2D point group by performing measurement by a ranging device 101 at the coordinates (normal_x, normal_y, normal_z). Each point included in the 2D point group has coordinates (x, y, z). Therefore, the data structure illustrated in section (a) may have a plurality of coordinates (x, y, z) for one coordinate (normal_x, normal_y, normal_z). Each of the coordinates (normal_x, normal_y, normal_z) and the coordinates (x, y, z) is not limited to the coordinates of a grid, and may be coordinates as a point.

In FIG. 16, section (b) illustrates an example of the data structure including the obstacle site information 220 indicating the position of the obstacle site and posture information 222 indicating a posture of the mobile device 10 when the obstacle site information is acquired in one data. More specifically, the obstacle site information 220 includes coordinates (x, y, z) of the grid detected as the obstacle site. Note that, a value of a coordinate z is fixed to 0. The posture information 222 includes roll, pitch, and yaw indicating the posture of the mobile device 10.

In the information processing device 100, for example, in a case where the map with angle information based on these data structures is used, an obstacle site recognition unit 113 may project each data onto an xy plane, and perform clustering processing or filtering processing to create two-dimensional map information. An action planning unit 114 may create a travel plan of the mobile device 10 using the two-dimensional map information.

There is no limitation, and for example, the obstacle site recognition unit 113 may perform three-dimensional to six-dimensional matching processing on the basis of the map with angle information of these data structures. For the matching processing, an algorithm based on a known generallized-interative closest point (GICP) may be applied. In the matching processing, basically, position search is performed in such a manner that a point and a point coincide with each other or approximate each other. In this case, for example, the obstacle site recognition unit 113 may perform the matching of the position in which not only coordinates (x, y, z) of the points coincide but also the posture information coincides or approximates. Furthermore, for example, the obstacle site recognition unit 113 may perform the matching of the position that most overlaps with an extracted point in which the posture information coincides or approximates.

In this manner, in the third embodiment, it is possible to detect the slope and the like without using a sensor capable of acquiring three-dimensional information, and create the travel plan based on a detection result. Therefore, by applying the third embodiment, the mobility of the autonomous mobile body can be improved at a low cost.

### 6. Fourth Embodiment

Next, a fourth embodiment of the present disclosure will be described. The fourth embodiment is an example of creating a map with angle information by adding angle information by a manual operation to an obstacle site map already created by, for example, an existing technology and the like.

A schematic diagram for describing creation of a map with angle information according to the fourth embodiment. For example, in an information processing device 100, a map creation unit 110 adds angle information and the like to an obstacle site map 500 according to the existing technology described with reference to FIG. 1 in accordance with a user operation using an input device 1005 (refer to FIG. 5).

For example, the map creation unit 110 generates a graphical user interface (GUI) screen for inputting the angle information by the user operation to the obstacle site map prepared in advance, and displays the same on a display 1030 (refer to FIG. 5). The GUI screen displays, for example, the obstacle site map prepared in advance and various tools for adding the angle information to the obstacle site map.

For example, the user designates a position in which the angle information is desired to be added to the displayed obstacle site map by using the tool displayed on the GUI screen by operating the input device 1005, and inputs the angle information to the designated position. The map creation unit 110 may configure the GUI to collectively input the angle information to a designated range by range designation with respect to the obstacle site map, or may configure the GUI to input the angle information for each grid. The map creation unit 110 creates the map with angle information by reflecting the input angle information on the displayed obstacle site map.

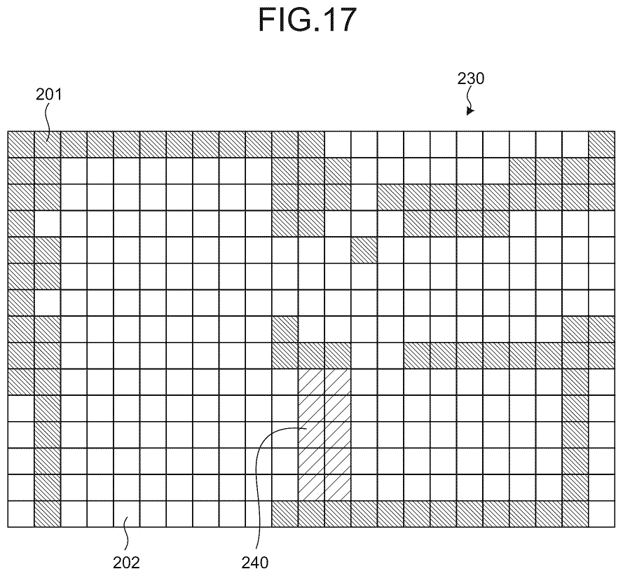

FIG. 17 is a schematic diagram illustrating an example of the map with angle information created by a method according to the fourth embodiment. A map with angle information 230 illustrated in FIG. 17 corresponds to the obstacle site map 500 described with reference to FIG. 1. The user inputs the angle information for a region indicated by a region 240 in FIG. 17 to the above-described obstacle site map 500. The map creation unit 110 creates the map with angle information 230 in which the information of the region 240 is overwritten with the input angle information, and stores the created map with angle information 230 in the map storage unit 111. The angle information may be a normal vector of each grid in the region 240 or posture information of the mobile device 10 in each grid. Information indicating a state of a travel surface such as a slope may be added to each position.

Note that, the map creation unit 110 may add an effect such as color coding for each angle according to the angle information, for example, to the map with angle information 230 by the GUI screen. As a result, the angle of the travel surface at each position can be visualized. By visualizing the angle information, for example, it is possible to reduce a burden of work when the user creates an application program for travel control of the mobile device 10 using this GUI tool and the like. For example, by visualizing the angle information in the map with angle information 230, it is possible to more easily correct the map with angle information 230.

Note that, the effects described in the present specification are merely examples and are not limitative, and there may be other effects.

Note that, the present technology can also have the following configurations.

(1) An information processing device comprising:
a map creation unit that creates a map on the basis of obstacle position information indicating a position of an obstacle site that obstructs travel by a mobile device, and angle information indicating an angle at each travel position at which the mobile device travels of the mobile device.

(2) The information processing device according to the above (1), wherein
the map creation unit
creates the map including the obstacle position information, and the angle information at each travel position.

(3) The information processing device according to the above (1) or (2), wherein
the map creation unit
uses posture information indicating a posture of the mobile device at each travel position as the angle information, and creates the map for each of pieces of the angle information indicating different angles

(4) The information processing device according to the above (3), wherein
the map creation unit
integrates maps for the respective pieces of the angle information on the basis of the travel position to create one map.

(5) The information processing device according to the above (3) or (4), wherein
the map creation unit
acquires the angle information according to a user input.

(6) The information processing device according to the above (1) or (2), wherein
the map creation unit
creates the map using normal information at each travel position of a travel surface on which the mobile device travels as the angle information.

(7) The information processing device according to the above (6), wherein
the map creation unit creates, as the map,
a normal information map using the normal information as the angle information, and an obstacle site map based on the obstacle position information.

(8) The information processing device according to any one of the above (1) to (7), wherein
the map creation unit
adds, to the obstacle position information, a position at which the obstacle site is detected, posture information indicating a posture of the mobile device at the position at which the obstacle site is detected, or inclination information on a travel surface on which the mobile device travels at the position at which the obstacle site is detected.

(9) The information processing device according to any one of the above (1) to (8), further comprising:
a travel control unit that controls the travel of the mobile device on the basis of the map created by the map creation unit.

(10) An information processing method comprising:
a map creation step of creating a map on the basis of obstacle position information indicating a position of an obstacle site that obstructs travel by a mobile device, and angle information indicating an angle at each travel position at which the mobile device travels of the mobile device,
the map creation step executed by a computer.

(11) An information processing program causing
a computer to execute:
a map creation step of creating a map on the basis of obstacle position information indicating a position of an obstacle site that obstructs travel by a mobile device, and angle information indicating an angle at each travel position at which the mobile device travels of the mobile device.

### REFERENCE SIGNS LIST

10 MOBILE DEVICE
100 INFORMATION PROCESSING DEVICE
101 RANGING DEVICE
102 IMU
103 MOTOR DRIVER
105 ODOMETRY PROCESSING UNIT
110 MAP CREATION UNIT
111 MAP STORAGE UNIT
112 SELF POSITION ESTIMATION UNIT
113 OBSTACLE SITE RECOGNITION UNIT
114 ACTION PLANNING UNIT
200, 200₁, 200₂, 200₃, 230, 250 MAP WITH ANGLE INFORMATION
201₁, 201₂, 201₃, 201, 201ₐ, 201_{b}, 201_{c}, 201_{d}, 201ₑ, 201_{f} OBSTACLE SITE
210, 212 HORIZONTAL SURFACE
211 SLOPE
220 OBSTACLE SITE INFORMATION
221 SELF DEVICE POSITION INFORMATION
222 POSTURE INFORMATION
400 NORMAL VECTOR
1000 CPU
1002 RAM
1005 INPUT DEVICE
1030 DISPLAY

1. An information processing device comprising:
a map creation unit that creates a map on the basis of obstacle position information indicating a position of an obstacle site that obstructs travel by a mobile device, and angle information indicating an angle at each travel position at which the mobile device travels of the mobile device.

2. The information processing device according to claim 1, wherein
the map creation unit
creates the map including the obstacle position information, and the angle information at each travel position.

3. The information processing device according to claim 1, wherein
the map creation unit
uses posture information indicating a posture of the mobile device at each travel position as the angle information, and creates the map for each of pieces of the angle information indicating different angles.

4. The information processing device according to claim 3, wherein
the map creation unit
integrates maps for the respective pieces of the angle information on the basis of the travel position to create one map.

5. The information processing device according to claim 3, wherein
the map creation unit
acquires the angle information according to a user input.

6. The information processing device according to claim 1, wherein
the map creation unit
creates the map using normal information at each travel position of a travel surface on which the mobile device travels as the angle information.

7. The information processing device according to claim 6, wherein
the map creation unit creates, as the map,
a normal information map using the normal information as the angle information, and an obstacle site map based on the obstacle position information.

8. The information processing device according to claim 1, wherein
the map creation unit
adds, to the obstacle position information, a position at which the obstacle site is detected, posture information indicating a posture of the mobile device at the position at which the obstacle site is detected, or inclination information on a travel surface on which the mobile device travels at the position at which the obstacle site is detected.

9. The information processing device according to claim 1, further comprising:
a travel control unit that controls the travel of the mobile device on the basis of the map created by the map creation unit.

10. An information processing method comprising:
a map creation step of creating a map on the basis of obstacle position information indicating a position of an obstacle site that obstructs travel by a mobile device, and angle information indicating an angle at each travel position at which the mobile device travels of the mobile device,
the map creation step executed by a computer.

11. An information processing program causing
a computer to execute:
a map creation step of creating a map on the basis of obstacle position information indicating a position of an obstacle site that obstructs travel by a mobile device, and angle information indicating an angle at each travel position at which the mobile device travels of the mobile device.
